(19) United States
(12) Patent Application Publication
(10) Pub. No.: US 2006/0173859 A1
(43) Pub. Date: Aug. 3, 2006

(54) Apparatus and method for extracting context and providing information based on context in multimedia communication system

(75) Inventors: Jun-Hwan Kim, Seoul (KR); Jung-Hee Ryu, Seoul (KR); Bong-Kyo Moon, Yongin-si (KR); Jun-Young Jung, Seoul (KR); Han-Na Lim, Siheung-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/321,935

(22) Filed: Dec. 29, 2005

(30) Foreign Application Priority Data
Dec. 30, 2004 (KR) 2004/116648

(51) Int. Cl. G06F 17/30

(52) U.S. Cl. 707/10

(57) ABSTRACT

An apparatus and a method for providing a multimedia service which can automatically recognize various media corresponding to communication contents and provide information regarding to the media in bi-directional or multipoint communication. The method includes the steps of classifying a type of input multimedia data, detecting context of the multimedia data through a search scheme corresponding to the classified multimedia data, determining a search request condition of related/accessory information corresponding to the detected context, receiving the related/accessory information about the context by searching the related/accessory information corresponding to the context if a related/accessory search condition is satisfied as a determination result of a search condition, and providing the multimedia data and the related/accessory information about the context of the multimedia data to a user.

### PRIORITY

This application claims priority to an application filed in the Korean Intellectual Property Office on Dec. 30, 2004 and assigned Serial No. 2004-116648, the contents of which are incorporated herein by reference.

### BACKGROUND OF THE INVENTION

1. Field of the Invention

The present invention relates to a system and a method for providing a multimedia service in a wireless communication system, and more particularly to an apparatus and a method which can provide a multimedia service including various accessory information when a user communicates with other user in a multimedia communication system.

2. Description of the Related Art

Generally, portable terminals (such as a portable phone and a personal digital assistant (PDA) terminal) have additional functions for performing personal data management and information exchange with a computer, in addition to a fundamental function of allowing communicating with a public switched telephone network (PSTN) subscriber, or another communication subscriber through a base station even when moving. Recently, portable terminals having superior performance and various functions for transmitting/receiving an image and/or a moving picture, and realizing stereo and virtual three-dimensional sound have been introduced. Additionally, these portable terminals may also be equipped with, MP3 (MPEG-1 Audio Layer-3) players and cameras.

Moreover, as portable terminals including a variety of additional functions, such as a control function for a still image or a moving picture, an information search function for internetworking with Internet, a data transmitting/receiving function, and a camera function including a photographing function and an image editing function, have been popularized, services for supporting the additional functions are becoming common.

In addition, a plurality of convenience devices for users are becoming commonplace on portable terminals. For example, devices for providing related information to a terminal's user(s) while the user(s) is/are engaged in a bi-directional or a multipoint communication are available.

In more detail, the devices for providing related information to users while the users are engaged in a bi-directional or a multipoint communication include an auto interpreter, a voice recognition device, and an accessory information transmitter. The auto interpreter converts a language used by a speaker into a language used by a listener so as to deliver the language to the listener. The voice recognition converts a voice language used by a speaker into a text language so as to display the text language on a terminal of a listener. The accessory information transmitter analyzes letters transmitted to a user terminal and searches for information corresponding to the letters so as to transmit the letters and the information at the same time.

In the meantime, as communication techniques advance, demands for gathering, providing, and utilizing various information of a communication using communication devices in the daily life of a user are increasing.

However, the portable terminals or convenience information providing terminals for users currently experience the following problems.

First, types of media are restricted. In other words, types of media provided by conventional techniques are restricted to voice (in the case of the auto interpreter and the voice recognition device) or letters (in the case of the accessory information transmitter) described above.

Second, types of context are restricted. In other words, types of context provided by the conventional techniques are restricted to keywords (e.g., in the case of an accessory information transmitter).

Third, a search scheme is restricted. In other words, a search scheme provided by conventional techniques is restricted to interpreting or searching for keywords.

Fourth, a display scheme is restricted. In other words, according to conventional techniques, it is only possible to listen to interpreted voice instead of original voice of a transmitter (in the case of the auto interpreter), to display letters corresponding to the voice transmitted by the transmitter (in the case of the voice recognition device), or to display accessory information with original information (in the case of the accessory information transmitter).

Fifth, since the devices for providing convenient services for users are specifically designed, the users must purchase the devices corresponding to desired services in order to receive each of the desired services. This can inconvenience users who would have to purchase and/or carry devices according to corresponding functions.

As described above, according to conventional techniques, users actually receive accessory information which is limited restricted to primitive information due to the limitation of media types, context types, search schemes, and display schemes. In addition, only limited uses for the received information are available to the user.

Accordingly, it is necessary to realize a system capable of providing various additional services and multimedia services to one or more users by means of a single device such as a portable terminal during a bi-directional or multipoint communication and a method for the same.

### SUMMARY OF THE INVENTION

Accordingly, the present invention has been made to solve the above-mentioned problems occurring in the prior art, and an object of the present invention is to provide a system and a method for providing a multimedia service, which can more conveniently provide various multimedia services to a user in a communication system.

Another object of the present invention is to provide a system and a method for providing a multimedia service which can check input data and provide related accessory information without an additional editing operation in real-time multimedia communication.

Still another object of the present invention is to provide a system, an apparatus, and a method, which can automatically recognize context input by a user through various multimedia services in a communication system, search a corresponding database for information regarding the recognized context, and transmit and/or receive the information, thereby providing various accessory information to the user.

Still another object of the present invention is to provide an apparatus and a method, which can automatically recognize and extract context for input data while a user is engaged in a multimedia communication in a communication system.

Still another object of the present invention is to provide a method for determining necessity of accessory information corresponding to contexts extracted from input data in a multimedia communication and performing a search operation according to the determination.

Yet another object of the present invention is to provide a system, an apparatus, and a method, which can enable an external search server to search various information using an Internet protocol and enable the provision of the searched data.

Still yet another object of the present invention is to provide an apparatus and a method, which can provide received multimedia data and searched accessory information to a user at the same time.

Still yet another object of the present invention is to provide an apparatus and a method, which can simply provide a multimedia service and related accessory information to a user through a user equipment.

To accomplish the above objects, there is provided an apparatus for extracting context and providing accessory information related to the context to provide multimedia data in a communication system. The apparatus includes a multimedia data receiving module for receiving multimedia data and related/accessory information corresponding to the multimedia data from one of a user equipment and a Web server, a context extracting module for extracting context of the multimedia data received through the multimedia data receiving module, a context classifying module for determining and classifying a type of the context extracted in the context extracting module, a search controller for determining a search request condition for related/accessory information about the context extracted and classified in the context extracting module and searching for the related/accessory information about the context according to the search request condition, and a related information providing module for converting the related/accessory information about the context searched by the search controller through a predetermined Interface scheme and providing the related/accessory information.

According to another aspect of the present invention, there is provided a user equipment enabling a multimedia service in a multimedia communication system. The user equipment includes an input module including an information input unit, an image acquisition unit, and a voice recognition unit, the information input unit receiving predetermined text information from a user, the image acquisition unit acquiring an external image, and the voice recognition unit receiving a predetermined audio signal, a multimedia data communication module for transmitting and receiving one of only multimedia data and multimedia data and related/accessory information about the context with a predetermined Web server through a network interface, a smart interpreter for extracting context of multimedia data received through the multimedia data communication module, determining and classifying a type of the extracted context, and searching and providing related/accessory information corresponding to the extracted and classified context, and an output module for simultaneously providing the received multimedia data and related/accessory information about the multimedia data.

According to still another aspect of the present invention, there is provided a method for extracting context of multimedia data and providing accessory information in a communication system. The method includes classifying a type of input multimedia data, detecting context of the multimedia data through a search scheme corresponding to the classified multimedia data, determining a search request condition of related/accessory information corresponding to the detected context, receiving the related/accessory information about the context by searching the related/accessory information corresponding to the context, if a related/accessory search condition is satisfied as a determination result of a search condition, and providing the multimedia data and the related/accessory information about the context of the multimedia data to a user.

According to still another aspect of the present invention, there is provided a method for extracting context and providing accessory information in a multimedia communication system. The method includes transmitting the multimedia data to a smart interpreter if predetermined multimedia data is requested, extracting by the smart interpreter a context for the multimedia data, searching related/accessory information corresponding to the extracted context, providing the related/accessory to a user equipment, and displaying the related/accessory information about the context together with the multimedia data, if the related/accessory information is received from the smart interpreter.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram schematically illustrating a system for realizing a multimedia service according to an embodiment of the present invention;

FIG. 2 is a block diagram illustrating a device for providing a multimedia service according to an embodiment the present invention;

FIG. 3 is a block diagram illustrating the internal structure of a user equipment according to an embodiment of the present invention;

FIG. 4 is a flowchart illustrating an operational procedure of providing a multimedia service according to an embodiment of the present invention;

FIG. 5 is a flowchart illustrating a procedure of extracting context according to input data types in order to provide a multimedia service according to an embodiment of the present invention;

FIGS. 6A and 6B are flowcharts illustrating a procedure of extracting context according to input data in order to provide a multimedia data service according to an embodiment of the present invention;

FIG. 7 is a flowchart illustrating a search operation according to context in order to provide a multimedia service according to an embodiment of the present invention;

FIG. 8 is a flowchart illustrating a search procedure and a searched data transceiving procedure for context according to an embodiment of the present invention; and

FIGS. 9A to 9D are screenshots illustrating a scheme of displaying a multimedia service according to an embodiment of the present invention.

### DETAILED DESCRIPTION OF THE PREFERRED EMBODIMENT

Hereinafter, preferred embodiments of the present invention will be described in detail with reference to the accompanying drawings. Please note, the same or similar components in drawings may be designated by the same reference numerals although they are shown in different drawings. In the following description of the present invention, a detailed description of known functions and configurations incorporated herein will be omitted when it may make the subject matter of the present invention unclear.

The present invention is directed to a system, apparatus and method for providing a multimedia service which can automatically recognize the context of various media, such as voice, video, or text, corresponding to communication contents in a bi-directional or multipoint multimedia communication and provide information about the context. The term “context” is used herein to represent an “information object”.

In other words, the term “context” as used herein is used to indicate a specific word, sentence, or language (e.g., a foreign language, etc.) in a case of voice or text and a specific video, person, trade mark, scene (e.g., a scene of a movie), an object in a case of a moving picture or a still image, and combinations thereof. In addition, the context can also be used to indicate a case in which other various media and the examples are integrated with each other.

In addition, it is noted that the term multimedia as used herein refers to voice, video, text, other media (in whole or in part), and/or combinations thereof.

Hereinafter, an apparatus capable of providing a multimedia service, which can automatically recognize the “context” of various media, such as voice, video, or text, corresponding to communication contents in bi-directional and multipoint multimedia communication and provide information about the context, will be referred to as a “smart interpreter” according to the present invention.

Hereinafter, a system for realizing a multimedia service according to the present invention and an apparatus for providing the service and a method using the same will be described with reference the accompanying drawings according to preferred embodiments of the present invention.

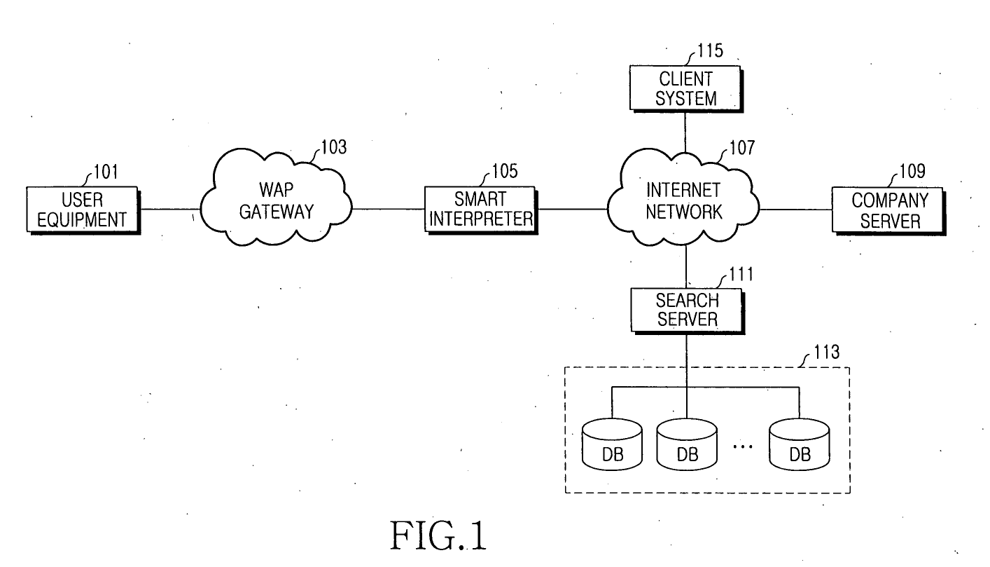

FIG. 1 is a block diagram illustrating a system for realizing a multimedia service according to an embodiment of the present invention.

The system for providing a multimedia service according to the present invention includes a user equipment 101, which includes an application capable of transceiving a variety of multimedia data and accessory information input from an external system, a Wireless Application Protocol (WAP) gateway 103 for wire/wireless Internet Communication, a smart interpreter 105, which recognizes and extracts context from multimedia data received according to bi-directional or multipoint communication, requests information regarding the extracted context from a search server 111, and receives the requested information, a wire/wireless Internet network 107, which provides an Internet service, a company server 109, which provides various data regarding its company through the Internet network, the search server 111, which decodes data searched by the company server 109 and stores the data according to types of the data, provides the stored data according to the request of the smart interpreter 105 by internetworking with the Internet network 107, a database (DB) 113, which stores the data searched by the search server 111 according to types of the data, and a client system 115, which communicates through the Internet network, requests accessory information regarding multimedia received through the Internet communication, and provides the requested accessory information to a user by receiving the requested accessory information from the search server 111.

The user equipment 101 includes a portable terminal, such as a mobile telephone, a PDA terminal, a smart phone, etc., equipped with a wireless Internet browser enabling the access to a wireless Internet or a computer network. Although the wireless Internet browser may be an WAP browser as an example, the present invention is not limited to the WAP browser. In addition, the WAP browser may be replaced with a generally-known wireless browser basically installed on a mobile phone terminal of each mobile communication company.

referably, the user equipment 101 may have the smart interpreter 105 embedded therein in order to realize a multimedia service according to the present invention. Since this structure will be described later, and detailed description about the structure is omitted at the present time for the sake of clarity.

The WAP gateway 103 provides an interface enabling the user equipment 101 to transmit and/or receive multimedia-type data through wire and/or wireless Internet by internetworking with a system (not shown) of a mobile communication company. The wire and/or wireless Internet is realized using a conventional information communication technique or the like. Since technical constitution relating to the wire and/or wireless Internet is generally known to those skilled in the art, more detailed description about the wire and/or wireless Internet will be omitted herein for the sake of clarity.

If data are transferred from the user equipment 101, the smart interpreter 105 automatically recognizes and extracts the context of the transferred data such as voice, video, or text, receives information corresponding to the context by internetworking with the search server 111, and provides the information received from the search server 111 to the user equipment 101 or the client system 115. The information corresponding to the context, that is, the information regarding the context represents a person, a company, a language, marketing, scheduling, related information, etc. Since description about the structure of the smart interpreter 105 will be given below, a description about the structure of the smart interpreter 105 will be omitted at this point for the sake of clarity.

The Internet network 107 is connected with the smart interpreter 105, the company server 109, the search server 111, and the client system 115 and provides an interface for wire and/or wireless communication with each device and an Internet service through the connection.

The company server 109 stores a variety of data relating to a company using a database, provides related information requested from the search server 111 through the Internet network 107, or databases for search of the search server 111.

The search server 111 searches for information regarding context requested by the smart interpreter through internetworking with a its database module 113 and provides the information, receives related information through the search request from the company server 109 corresponding to the context, and provides the searched information or the received information to the smart interpreter 105. In this case, the database module 113 includes a plurality of databases for storing information related to the context requested by the smart interpreter 105 and information according to types of data classified by means of the search server 111.

The database module 113 includes a person database including various information corresponding to a specific person when data classified and output in the search server 111 relates to the specific person, a company database including various information about a company corresponding to a trademark and about the trademark when the data classified and output in the search server 111 relates to the trade mark for the company, a dictionary (e.g., Chinese dictionary) including various information about (Chinese) characters when the data classified and output in the search server 111 relates to the Chinese language, and an English-Korean (or other languages as desired) dictionary including Korean work and/or phrases corresponding to English words and/or phrases when the data classified and output in the search server 111 relates to the English and/or phrases.

The client system 115 includes a network interface enabling access to an Internet browser and wire and/or wireless Internet and may be a desk top computer, a note book computer, and other user equipment.

As described above, description about the structure of the system for providing a multimedia service according to the present invention is schematically given. Hereinafter, the smart interpreter for providing a multimedia service according to the present invention will be described in more detail.

Structure of Smart Interpreter

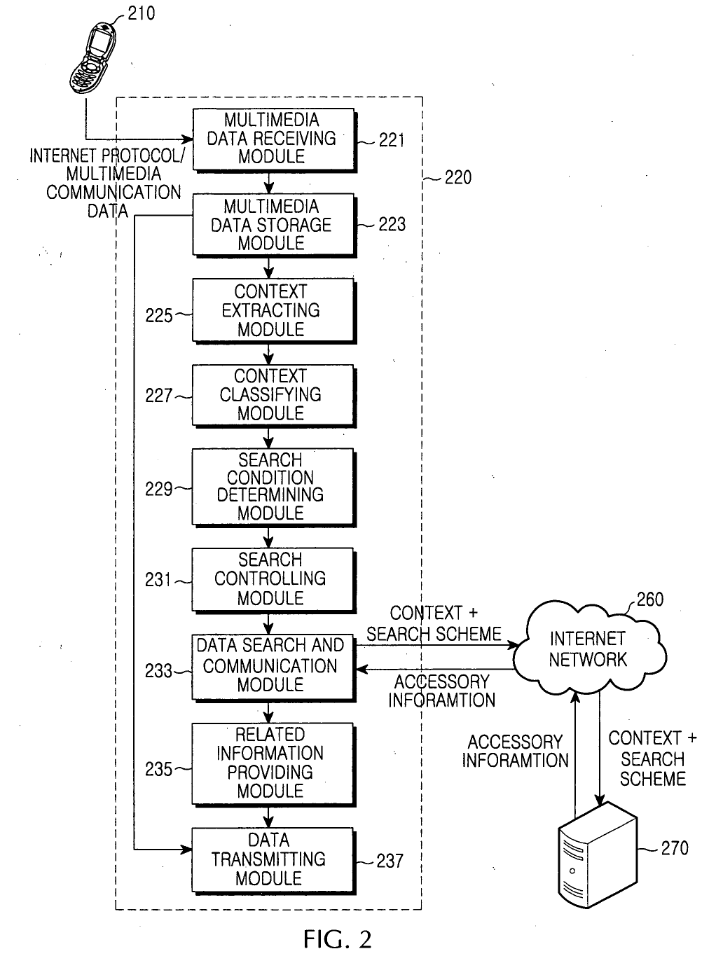

FIG. 2 is a block diagram illustrating the smart interpreter for providing a multimedia service according to the present invention.

The smart interpreter 220 includes a multimedia data receiving module 221, which receives multimedia data from the user equipment 210 or a Web server (e.g., the company server, or the search server) by using an Internet protocol, a multimedia data storage module 223, which stores multimedia data received from the multimedia data receiving module 221, a context extracting module 225, which extracts context from multimedia data stored in the multimedia data storage module 223, a context classifying module 227, which determines and classifies types of context extracted from the context extracting module 225, a search condition determining module 229, which detects a situation corresponding to a search condition input from the user, a search controlling module 231, which determines the situation determined in the search condition determining module, that is, the search condition of a user for information regarding the extracted and classified context and controls a search scheme for the information of the extracted context according to the search condition of the user, a data search and communication module 233, which searches required information in an external search server 270 using an Internet protocol and receives the searched data, a related information providing module 235, which provides information regarding multimedia data by determining information about the searched data through the search controlling module 231, that is, information regarding context searched through the search controlling module 231. Preferably, the smart interpreter 220 further includes a data transmitting module 237 which provides the searched information to the user equipment 210 according to the setting up of a user or a service provider.

As described above, the smart interpreter 220 according to the present invention is included within or is attached to of the user equipment 210, extracts context of corresponding data by receiving the data input from a user, and delivers information relating to the context to the user equipment 210 by searching or receiving the information using the smart interpreter's database or using other databases (DBs) through a network. The databases store information about a person, a company, a language, marketing, schedule, and the others relating to the context by making fields with respect to information about at least one of the person, the company, the language, the marketing, and the schedule, and the others. In more detail, the data bases include a person information field including related/accessory information corresponding to a specific person such as the profile, the video, the academic background, activities, special skills, and the hobby of the person, a company information field including related/accessory information corresponding to a specific company such as the corporate identity, the brand identity, stock information, officer information, goods information, and the logo of the company, and a language information field including an electronic dictionary for providing related/accessory information corresponding to text such as a specific Chinese character, an English character or the like.

In the meantime, as described above, it can be understood that the smart interpreter according to the present invention is constructed as a separated system in such a manner that the smart interpreter is connected with the user equipment, the search server, and the client system through an external Internet network. However, since the present invention is not limited to this structure, the smart interpreter can be included in the user equipment, the search server, or the client system. For example, the smart interpreter may be realized through an application in the user equipment or the search server. In addition, it is natural that the function blocks of the smart interpreter are realized using a single hardware chip.

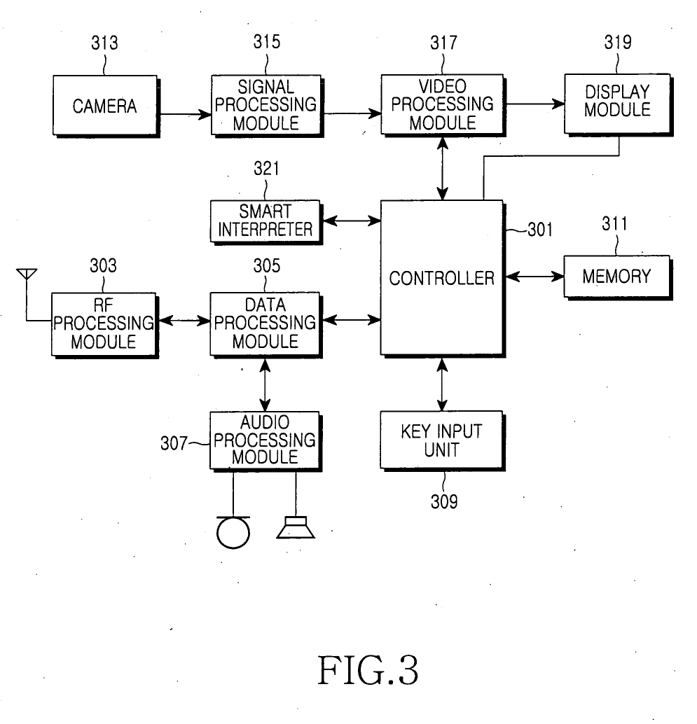

Hereinafter, an example in which the smart interpreter is constructed inside of the user equipment will be described with reference to FIG. 3.

FIG. 3 is a block diagram illustrating the internal structure of the user equipment including the smart interpreter for providing a multimedia service according to an embodiment of the present invention.

The user equipment according to an embodiment of the present invention includes a data input unit, a data processing unit, a data storing unit, a data output unit, and a data communication unit. The data input unit includes an audio processing module 307 for processing voice data input through a microphone, a key input unit 309 for receiving character data from the user, a camera 313 for receiving video data corresponding to an external object. In other words, the input unit receives multimedia data such as voice data, character data, and video data by means of the components thereof.

The data processing unit includes a signal processing module 315, which converts the video data input through the camera 313 into a digital signal and processes the converted signal, a video processing module 317, which processes the input video data digitalized in the signal processing module 315, a data processing module 305, which processes voice data delivered from the audio processing module 307 or character data received from the user through the key input module 309, a controller 301, which controls blocks in the user equipment, and a smart interpreter module 321, which recognizes and extracts context from multimedia data input through the data input unit, requests and receives related information corresponding to the extracted context from the external web server and provides the related information to the user. In other words, the data processing unit suitably processes multimedia data such as the voice data, the character data, and the video data input from the data input unit.

The data storing unit stores the multimedia data input through the data input unit and information relating to the context transmitted from the external Web server and includes a memory 311.

The data output unit includes a display module 319, which generates a video to be provided to the user with respect to the multimedia data input from an external device and outputs the video, and the audio processing module 307, which outputs the voice data to an external device. In other words, the data output unit outputs voice data relating to multimedia data input through the data input unit and multimedia data stored in the data storing unit.

The data communication unit wirelessly transmits the multimedia data to another user of an external system or transceives information relating to context by internetworking with the external Web server. In addition, the data communication unit includes a radio frequency (RF) processing module 303.

Hereinafter, more detailed description about each component will be given. The RF processing module 303 performs portable phone communication, data communication, etc. The RF processing module 303 includes an RF transmitter for up-converting and amplifying a frequency of a signal to be transmitted and an RF receiver for low-noise amplifying a received signal and down-converting a frequency of the received signal. The data processing module 305 includes a unit for performing encoding and modulation with respect to a signal transmitted through the RF processing module 303 and a unit for performing demodulation and decoding with respect to a signal received through the RF processing module 303.

The audio processing module 307 reproduces an audio signal output from the data processing module 305 or transmits an audio signal such as voice input from the microphone to the data processing module 305. The key input unit 309 receives numeric information and character information and includes numeric, character and/or function keys for setting up a variety of functions. The function key includes a mode setting key for receiving a multimedia service according to the present invention and a search input key used for inputting a search condition according to types of context.

The memory 311 includes a program memory and data memories. The program memory may store program modules for controlling a general operation of the user equipment and program modules including an application used for a multimedia service according to an embodiment of the present invention. The data memories temporarily store data generated while performing the program modules.

The controller 301 controls the operation of the user equipment. In addition, if a mode setting change signal is input from the key input unit 309, the controller 301 controls mode setting corresponding to the mode setting change signal and performs a control operation in such a manner that multimedia data created or managed correspondingly to the input mode setting signal are displayed. The controller 301 controls a path of transmitting the multimedia data to the following display module 319 according to an embodiment of the present invention.

The camera 313 receives a data signal as a result of photographing a predetermined object and performs digital signal conversion of video data received through internetworking with an encoder (not shown). The signal processing module 315 converts a video signal output from the camera 313 into an screen image signal.

The video processing module 317 generates screen image data used for displaying a video signal output from the signal processing module 315. The video processing module 317 transmits a video signal received under the controller 301 correspondingly to the display module 319. In addition, the video processing module 317 compresses and extends the video data.

The display module 319 displays video data output from the video processing module 317 on a screen as an image. In addition, multimedia data received through multimedia communication and accessory information regarding the multimedia data are provided according to a predetermined display scheme.

The smart interpreter 321 automatically recognizes and extracts context from multimedia data received through multimedia communication, searches information regarding the extracted context or requests the information from the external search server, and controls the searched or received information through the display module 319 such that multimedia data and searched results can be provided at the same time.

Preferably, the smart interpreter 321 may be equipped with a dedicated application including a program module of overlaying information regarding predetermined contexts, a program module of recognizing information regarding the contexts, a program module for extracting information about the contexts, and a program module capable of converting and managing the recognized information. In addition, it is preferred that the dedicated application is received by upgrading a firmware of the user equipment from a communication company system (not shown). However, the present invention is not limited to such.

The communication company system (not shown) may be a system of a mobile communication provider who provides a variety of additional services to the user equipment through an wire and/or wireless Internet. The communication company system provides user information of the user equipment by internetworking with its own database and distributes the dedicated application of the user equipment through the connection to the wire and/or wireless Internet.

Preferably, the smart interpreter 321 includes a multimedia data receiving module, which receives multimedia data from an external Web server by using an Internet protocol, a context extracting module, which extracts context from multimedia data received from the multimedia data receiving module, a context classifying module, which determines and classifies types of context extracted from the context extracting module, a search condition determining module, which detects a situation corresponding to a search condition input from the user through the context classifying module or the key input module 309, a search controlling module, which controls a search scheme of the context corresponding to the situation determined in the search condition determining module, and a related information providing module, which provides information regarding context searched through the search controlling module.

Preferably, although the search condition determining module and the search controlling module may be individually constructed, the search controlling module may be realized in such a manner that the search controlling module determines a search condition of a user for information regarding the extracted and classified context and searches for the information regarding the extracted context corresponding to the search condition of the user.

As described above, according to the present invention, although the user equipment is limited to a mobile communication apparatus or a portable phone for the purpose of description, the present invention is not restricted to this. For example, it is natural that the user equipment according to an embodiment of the present invention is applied to information and/or communication appliances, multimedia appliances, mobile terminals, such as mobile phones, PDAs terminal, smart phones, Digital Multimedia Broadcasting (DMB) phones, MP3 players, and digital cameras, and the like.

As described above, a description about the structure of the smart interpreter for realizing a multimedia service according to the present invention is given. Hereinafter, description about an operation of the smart interpreter for providing a multimedia service according to the present invention will be given.

Operation of Smart Interpreter

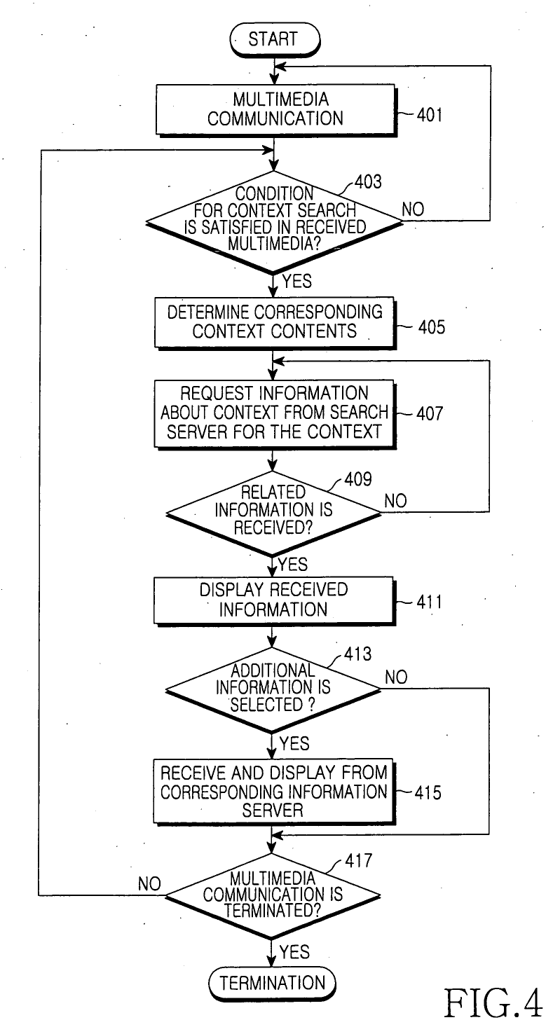

FIG. 4 is a flowchart schematically illustrating an operational procedure of the smart interpreter for providing a multimedia service according to an embodiment of the present invention.

If communication for a multimedia service is performed in an idle state (step 401), it is determined that context satisfying a search condition for related/accessory information exists in received multimedia data (step 403). If there is no context satisfying the search condition for the related/accessory information as the determination result, the procedure enters into the initial idle state (step 401) and basic multimedia communication is continuously performed. On the other hand, if context satisfying the search condition for the related/accessory information exists in the received multimedia data (step 403), the smart interpreter determines the contents of the context (step 405), the smart interpreter requests related/accessory information for the context from a search server corresponding to the determined context (step 407).

If accessory information about the context is received from the related search server after requesting the accessory information about the context corresponding to the search condition (step 409), the received accessory information is displayed by overlaying the accessory information on the multimedia data (step 411). In this case, even though the accessory information is displayed through the overlay, the accessory information may be displayed using a pop-up screen. Since the scheme of displaying the accessory information will be described later, the description about the scheme is omitted at this time for the sake of clarity.

A characteristic difference between the embodiment of the present invention described above and conventional techniques exists in that context is extracted, related/accessory information is searched and received, and the received searched data is provided to a display module of a user equipment together with the multimedia data while making communication for multimedia data corresponding to original data. The provision may be achieved through the overlay scheme described above, a screen division, or a pop-up scheme. However, since the present invention is not limited to this, it is also possible to provide another data while stopping the display of present data or storing the present data in a temporary buffer.

In the meantime, if the accessory information about the context is not received from the search server, it is preferred that request for the accessory information about the context is repeated a predetermined number of time, set by the system or the user. In addition, preferably, if the accessory information about the context is not received from the search server, it is recognized that the information about the context does not exist, and it is reported to the user that there is no information about the context through a visible scheme, an audible scheme, and a visible and audible scheme.

Thereafter, it is determined (step 413) that a request for further information about the context is selected, after the related/accessory information about the context is displayed, the further information from the related search server is requested again, and then the further information is provided to a user (step 415). In addition, it is determined that next further information is requested after the corresponding information is provided. If another information is requested, the above steps are repeated. If another information is not requested any longer, a next step is performed.

If accessory information about the context is completely provided, it is determined if the multimedia data communication is finished (step 417). If the multimedia data communication is not finished, the series of steps are repeated. If the multimedia data communication is finished, the multimedia data service is terminated. If the user requests accessory information, corresponding accessory information is received from a server and displayed. In this case, communication is continuously performed.

As described above, the operation of the smart interpreter according to the present invention is described. Hereinafter, the main characteristic operation of the smart interpreter will be described in more detail.

Operation of Extracting Context

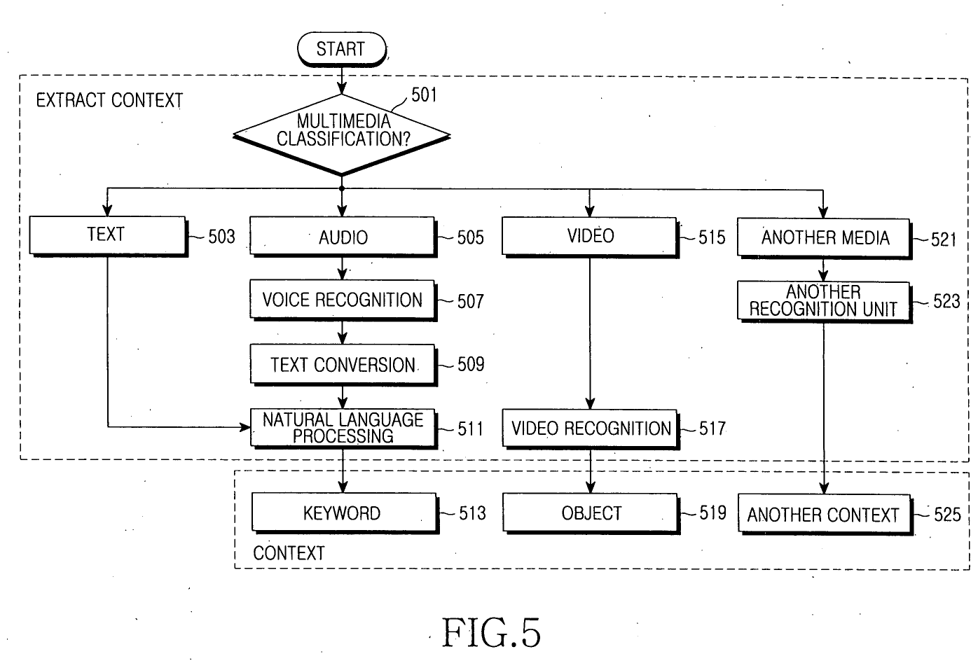

FIG. 5 is a flowchart illustrating a procedure of extracting context according to input data types in order to provide a multimedia service according to an embodiment of the present invention and, in particular, illustrating a procedure of extracting context from the input data through voice recognition, natural language processing, and image recognition.

If multimedia data are received according to multimedia data communication, the type of the received multimedia data is determined (step 501). For example, the received multimedia data are classified according to types thereof such as text, audio (i.e., voice), video, and other media (as shown in steps 503, 505, 515, and 521, respectively). In order to determine the type of the received multimedia data, type information relating to data form is included in the header of the multimedia data, which is a front part of the multimedia data. Accordingly, the type of the multimedia data is classified based on the header of the multimedia data. Thus, it is possible to determine the data form of the received multimedia data.

For example, based on “content-type” of a data header in Multipurpose Internet Mail Extensions (MIME), “content-type:text” indicates that corresponding multimedia data are text data, “content-type:video” indicates that corresponding multimedia data are moving picture data, and “content-type:audio” indicates that corresponding data are voice data.

In the meantime, if it is determined that the multimedia data are text data (step 503), keywords are extracted from the received text data through a natural language processing procedure (steps 511 and 513).

If it is determined that the multimedia data are audio (i.e., voice) data (step 505), the voice data are converted into text data through a voice recognition procedure (steps 507 and 509). Thereafter, the converted text data are received, and keywords are extracted from the text data through the natural language processing procedure (steps 511 and 513).

If it is determined that the multimedia data are video data (step 515), a specific object are extracted from the received video data through an image recognition procedure (steps 517 and 519).

In the meantime, if it is determined that the multimedia data are another media except for the above-described media (step 521), context corresponding to the received media are extracted through a recognition unit corresponding to the received media (steps 523 and 525). If voice data are received together with video data, the voice data and the video data may be individually processed according to a user's setting. In addition, if the voice data are received together with the video data, priority may be previously given to each of data simultaneously received as described above, and the data may be automatically processed in sequence according to the priority. However, the present invention is not limited to such.

Hereinafter, a procedure of extracting context according to input data described above will be described as an example.

For example, if voice data (corresponding to the phrase “Let's get to the point because I have not spare time”) is input, the input voice data is converted into text data such as “Let's get to the point because I have not spare time” using the voice recognition procedure. Thereafter, keywords including “time” and “point” are extracted from the converted text data through the natural language processing procedure.

As described above, according to the present invention, the procedure of extracting context according to input data is described. Hereinafter, a procedure of extracting context according to input data will be described in more detail.

Prior to the description about the procedure of extracting context according to the present invention, the process of detecting an object from a specific image or field is well known and researched. In particular, when the position of a desired object is not recognized, a scheme for employing a neural network or a matching scheme of employing a template can be used.

Herein, a neural network is generally used to refer to models for mathematically analyzing and researching the principle of parallel processing for information using a neural network. In addition, the neural network can be applied using fields such as computational neural science and psychology of cognition in addition to an engineered system. A scheme of extracting a face image of a person using a neural network is disclosed in “Neural Network-Based Face Detection” (by H. A. Rowley, S. Baluja, and T. Kanade, IEEE Transaction on Pattern Analysis and Machine Intelligence, volume 20, number 1, pages 23-38, January 1998).

In addition, the template represents a standardized pattern of a picture or an image previously determined in order to be frequently used in the graphic program. A programmer personally makes the template of an object or previously stores the template of the object obtained through a learning process, compares the template with an input image, and then, if it is determined that the template and the input image match, the position of an object from the input image is determined.

A matching scheme using the template has been variously suggested according to used features. In other words, context may be extracted from the received data using a generally known technique such as “Detecting Faces in Images” (by M. Yang, IEEE Transaction on Pattern Analysis and Machine Intelligence, vol. 24, no. 1, pp. 34-58, January, 2002) and “Robust Real-time Object Detection” (by P. Viola, Technical Report Series, pp. 283-289, February, CRL 2001.). In addition, schemes of detecting an object in an image locally or wholly having serious brightness differences are disclosed in “Shape-Based Object Recognition Using Multiple Distance Images” (by K. S. Shin, H. C. Choi and S. D. Kim, Proceedings IEEK Autumn Conference, 17-20, 2000, 11) using an edge as feature information and “Face recognition using kernel eignefaces” (by Yang, IEEE ICIP 2000, Vol., pp. 37-20) employing a linear projection scheme such as Principal Component Analysis (PCA) or Fisher's Linear Discriminant (FLC) as a feature extracting scheme.

Additionally, it is possible to extract context using a variety of generally-known techniques, and the present invention provides various related information to a user through the context extraction. Since more detailed schemes of extracting the context depart from the scope of the present invention, a detailed description about the context extraction will be omitted herein for the sake of clarity.

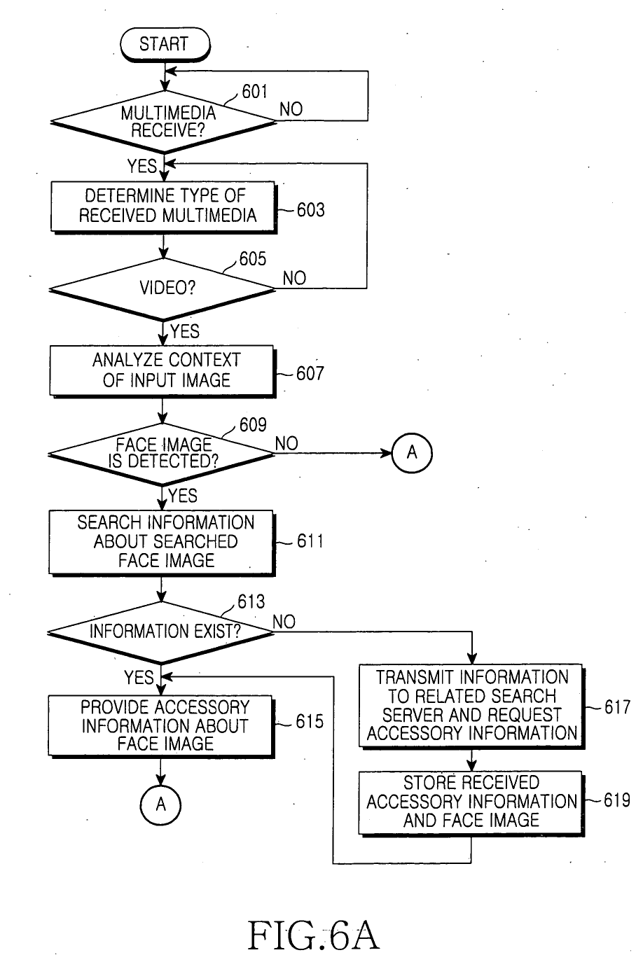

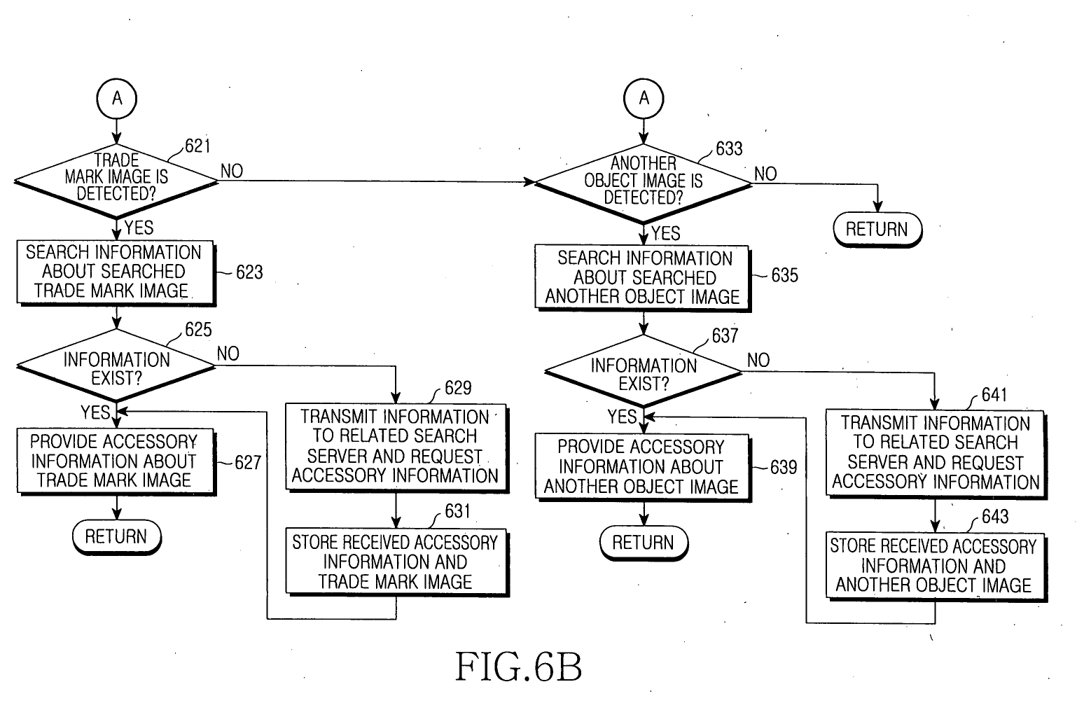

FIGS. 6A and 6B are flowcharts illustrating a procedure of extracting context according to input data in order to provide a multimedia data service according to an embodiment of the present invention and, in particular, a procedure of extracting and providing context from an image through image recognition if the input data are image data.

It is determined if multimedia data are received (step 601). If the multimedia data are received, the type of the multimedia data is determined (step 603). In this case, if the determined multimedia data are image data (step 605), context for the input image data are detected and extracted (step 607). In other words, a training image of an object is acquired from the input image, and the area of the object is detected and extracted. In this case, the image (e.g., video) data includes a still image or a moving picture.

In the meantime, if a face image is detected from the training image of the object (step 609), information about the face image is searched on a person database (DB) (step 611). Thereafter, it is determined if accessory information corresponding to the detected face image exists in the person DB (step 613). If the accessory information corresponding to the detected face image exists in the person DB, the searched accessory information is provided (step 615). If the accessory information corresponding to the detected face image does not exist in the person DB, related information corresponding to the detected face image from the related search server is requested (step 617). Thereafter, if the information about the detected face image is received from the related search server, the detected face image and the related accessory information are stored in the person DB (step 619). Thereafter, the accessory information about the detected face image is provided (step 615).

If a trade mark image is detected from the training image of the object (step 621), it is determined if accessory information corresponding to the detected trade mark image exists in the company DB (step 625) by searching the company DB (step 623). If the accessory information corresponding to the detected trade mark image exists in the company DB, the searched accessory information is provided to a user (step 627). If the accessory information corresponding to the detected trademark image does not exist in the company DB, related information about the detected trade mark image from the related search server is requested (step 629). Thereafter, if the information about the detected trade mark image is received from the related search server, the detected trade mark image and the related accessory information are stored in the company DB (step 631). Thereafter, the accessory information about the detected trade mark image is provided (step 627).

If the image of another object except for the objects (a face and a trademark) is detected from the training image of the object (step 623), it is determined if accessory information corresponding to the object image exists in a DB corresponding to the object image (step 637) by searching the DB (step 635). If the accessory information corresponding to the detected object image exists in the company DB, the searched accessory information is provided to a user (step 639). If the accessory information corresponding to the detected object image does not exist, related information about the detected object image from the related search server is requested (step 641). Thereafter, if the information about the detected object image is received from the related search server, the detected object image and the related accessory information are stored in the corresponding DB (step 643). Thereafter, the accessory information about the detected object is provided (step 639).

As described above, if a specific person image is received through multimedia such as a moving picture or a still image according to the present invention, a part having a face image is extracted from the received person image. In addition, if specific trade mark data are received through the multimedia, a part having the trade mark is extracted from the received trade mark data. In addition, if a specific person image is received together with a specific trademark image through the multimedia data, the part having the trade mark image and the part having the face image are individually extracted from the received person and trade mark images, respectively. As described above, context extraction through image recognition may be achieved by using the conventional neural network scheme or the conventional template matching scheme as described above. However, the present invention is not limited to this, so various schemes can be applied to embodiments of the present invention.

Determination for Necessity of Accessory Information

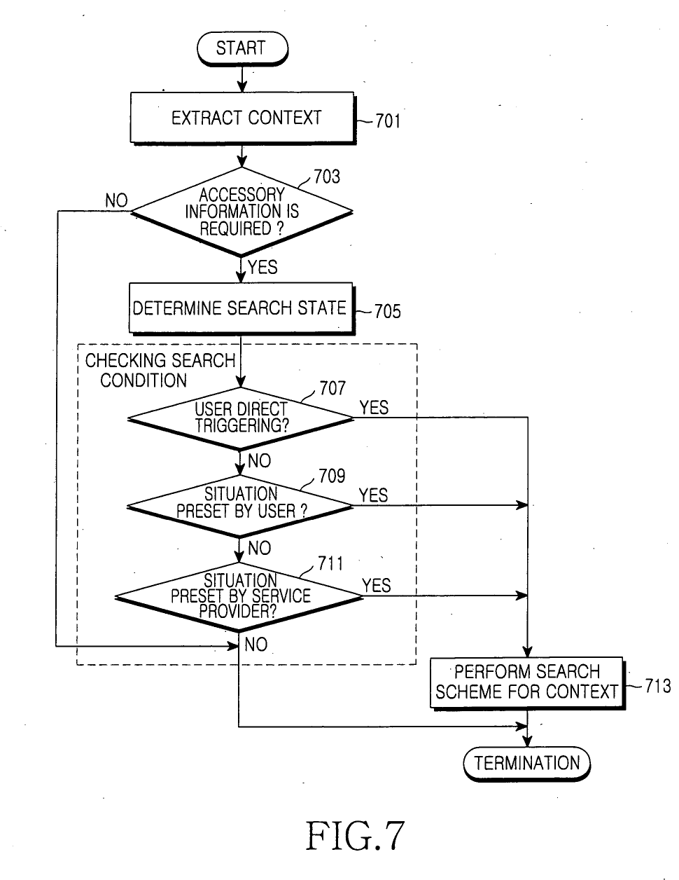

FIG. 7 is a flowchart illustrating a procedure of determining if accessory information is searched with respect to contexts extracted in order to provide a multimedia service according to the present invention.

It is determined if the search is achieved with respect to context extracted according to the present invention through a search condition (i.e., the direct triggering of a user, a situation previously specified by the user, or a situation previously specified by a service provider).

As shown in FIG. 7, if context is extracted (step 701), it is determined if the extracted context requires accessory information thereabout (step 703). If the extracted context requires the accessory information thereabout, it is determined if search is achieved with respect to the extracted context (step 705).

In this case, the determination for the search is achieved by checking the search condition. First, in the case of a search condition through the direct triggering of the user (step 707), an external effect is generated through a specific button pressed by the user, or the extracted context is clicked, so that accessory information is requested. If the accessory information is requested, a search scheme corresponding to the context selected by the user and the search condition is performed (step 713).

Second, in the case of a search condition through the situation previously specified by a user (step 709), it is determined if the search condition corresponds to the situation previously specified by the user through an input unit. If the search condition corresponds to the situation previously specified by the user as the determination result, a search scheme corresponding to context selected by the user and the search condition is performed (step 713). For example, the user can previously set that a conditional search is performed in cases of “If the image of a person with a square face is detected, express his/her personal data”, “If a Chinese character above the level of a middle school is detected, annotate the Chinese character”, “If English is detected, express corresponding Korean”, etc. If the set condition is satisfied in the set condition, a search scheme corresponding to the condition is performed.

Third, in the case of a search condition through a situation previously specified by a service provider, it is determined if the search condition corresponds to the situation previously specified by the service provider. If the search condition corresponds to the situation previously specified by the service provider as the determination result, a search scheme corresponding to the extracted context and the search condition is performed (step 713). For example, the service provider may set that information about a corresponding client company thereof is pushed to the user equipment if the trade mark of the client company is detected. If the search condition is satisfied in the extracted context, the search scheme corresponding to the search condition is performed.

In the meantime, as described above, the determination procedures according to three search conditions for the extracted context are described. However, the present invention is not limited to such.

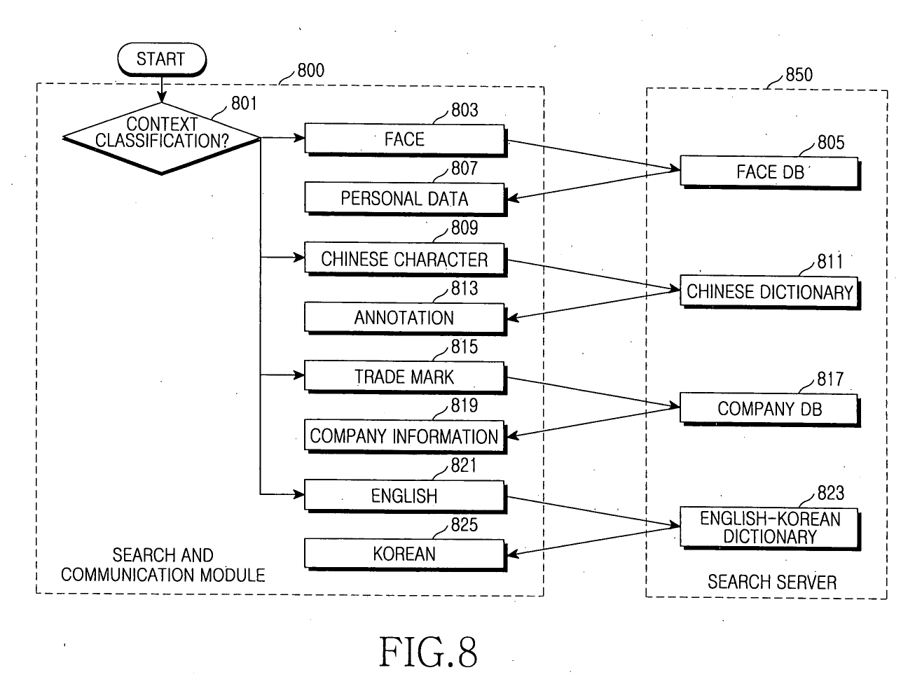

Hereinafter, the context described above and a search scheme corresponding to the context will be described in more detail with reference to FIG. 8.

Provision and Search of Accessory Information Using Network

FIG. 8 is a flowchart schematically illustrating a search procedure and a search data transceiving procedure for context according to an embodiment of the present invention and, in particular, a search procedure of an external search server using an Internet protocol and a search data receiving procedure.

In description about extracted context and a search scheme for the context, a search and communication module 800 classifies contexts through a context classifying procedure and transmits a search request corresponding to a context according to the classification of the contexts to a search server 850.

For example, if a context classified through the context classifying procedure corresponds to a face 803, the face is transmitted to the search server 850. The search server having received the face inter-networks with a person DB 805 and searches for a corresponding person by using the face as an index. Thereafter, the search server 850 transmits the searched information about the person to the search and communication module 800. The search and communication module 800 receives the person information 807 corresponding to the face 803 from the search server 850 and provides the person information.

In addition, if the classified context corresponds to a Chinese character 809, the Chinese character is transmitted to the search server 850. The search server having received the Chinese character inter-networks with a Chinese dictionary 811 and searches for the Chinese character by using the Chinese character as an index. Thereafter, the search server 850 transmits the search annotation about the Chinese character to the search and communication module 800. The search and communication module 800 receives the annotation 813 corresponding to the Chinese character 809 from the search server 850 and provides the annotation.

If the classified context is a trademark 815, the trademark is transmitted to the search server 850. The search server having received the trade mark inter-networks with a company DB 817 and searches for a corresponding company by using the trade mark as an index. Thereafter, the search server 850 transmits the search company information to the search and communication module 800. The search and communication module 800 receives the company information corresponding to the trade mark from the search server 850 and provides the company information.

If the classified context is an English word 821, the English word is transmitted to the search server 850. The search server having received the English word inter-networks with a English-Korean dictionary 817 and searches for a corresponding Korean word by using the English word as an index. Thereafter, the search server 850 transmits the search Korean word to the search and communication module 800. The search and communication module 800 receives the Korean word from the search server 850 and provides the Korean word.

As described above, a search procedure according to the classification of a context and a search data transceiving procedure according to the search procedure are described. However, the present invention is not limited to such. For example, in a case in which the classified context is an English word, the English word may be converted into an Korean word, and the meaning of the English word may be interpreted. For example, the English word is transmitted to the search server 850. The search server having received the English word inter-networks with a monolingual dictionary 817 and searches for corresponding explanation by using the English word as an index. Thereafter, the search server 850 transmits the search explanation to the search and communication module 800. The search and communication module 800 receives the explanation corresponding to the English word from the search server 850 and provides the explanation corresponding to the English word.

In the meantime, the multimedia data and the searched accessory information described above can be provided to a user through an image displaying module at the same time. Hereinafter, a scheme of displaying the multimedia data and the searched accessory information on the image displaying module will be described in more detail.

Scheme of Simultaneously Providing Received Data and Accessory Information Thereof

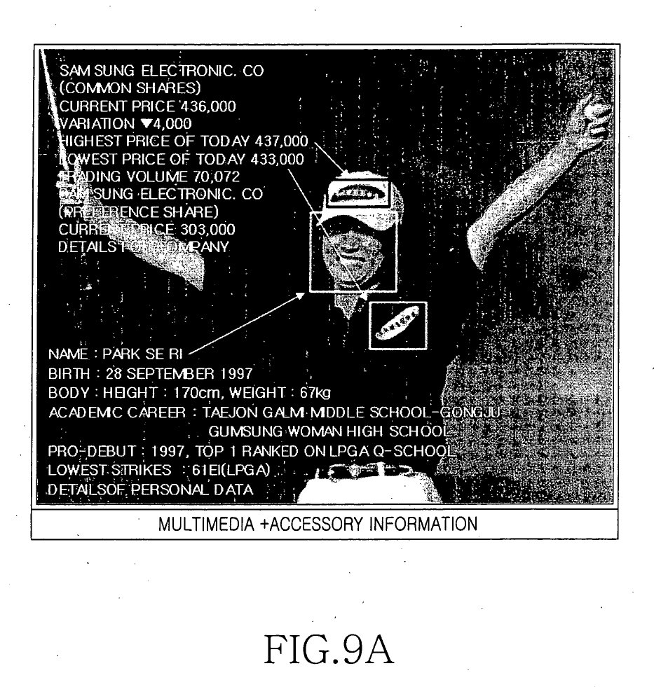

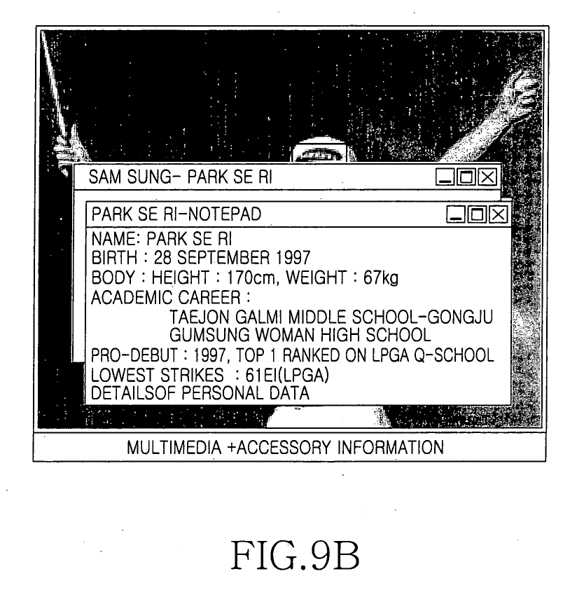

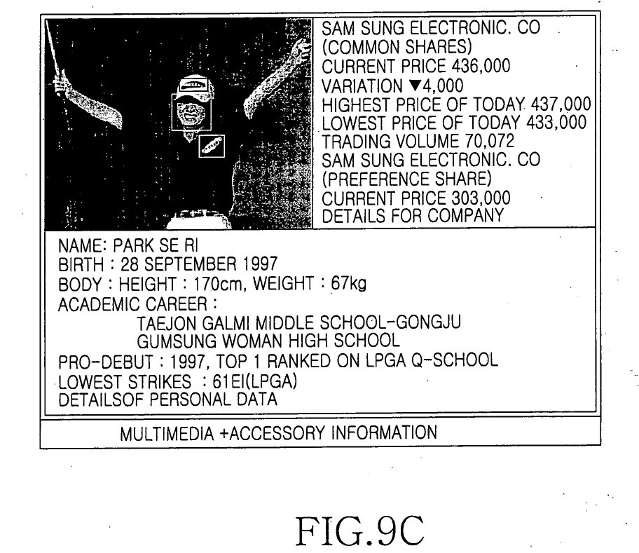

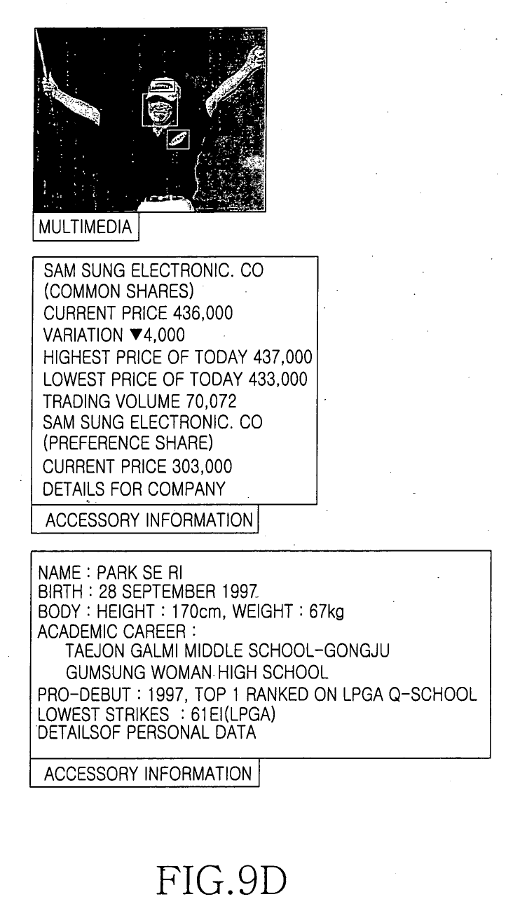

FIGS. 9A to 9D are views for explaining a scheme of displaying a multimedia service according to an embodiment of the present invention and, in particular, a scheme of simultaneously providing the received multimedia data and the searched accessory information to a user according to an embodiment of the present invention.

As shown in FIGS. 9A to 9D, various display schemes through internetworking with the image displaying module according to the present invention exist according to the setting up of a service provider or a user. For example, the searched accessory information may be overlaid on the received multimedia data (see FIG. 9A), or displayed using a pop-up window while reproducing the received multimedia data (see FIG. 9B). The received multimedia data and the searched accessory information may be displayed through divided windows of one screen image, respectively (see FIG. 9C). In addition, the received multimedia data and the searched accessory information may be displayed through different windows of following screens, respectively (see FIG. 9D). However, the present invention is not limited to this, so it is possible that the mixture or combination of the above schemes is employed for displaying data and information.

As described above, according to an apparatus and a method for extracting context and providing information based the context in multimedia communication of the present invention, context for various types of media corresponding to communication contents in bi-directional and multipoint communication is recognized and extracted by means of a smart interpreter constructed inside of a user equipment or through an external server, so that it is possible to receive information regarding the context from a server in real time. Accordingly, various accessory information and various search services are provided to a user, so that it is possible to secure more many subscribers through a service with which the demand of users are satisfied.

Additionally, in the conventional multimedia communication, if a receiver does not understand communication contents transmitted by a transmitter, the receiver must continuously make communication with the transmitter without any question or comprehension about the communication contents. However, related information is received from a server in real-time according to the present invention, so that it is possible to raise the degree of the comprehension of the receiver.

Various information and various search services for received multimedia data through multimedia communication are provided without an additional operation of a user for the received multimedia data, so that the demand of the user is satisfied, and inconvenience for checking by a user information about multimedia and inconvenience according to a search operation are resolved. Therefore, it is possible to increase the convenient for the user.

In addition, a smart interpreter constructed inside of a user equipment and through an external server can provide various types of accessory information for various types of multimedia data as well as the conventional limited translation/interpretation by internetworking with various types of search servers in real time.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. An apparatus for extracting context and providing accessory information related to the context to provide multimedia data in a communication system, the apparatus comprising:
a multimedia data receiving module for receiving multimedia data and related/accessory information corresponding to the multimedia data from one of a user equipment and a Web server;
a context extracting module for extracting context of the multimedia data received through the multimedia data receiving module;
a context classifying module for determining and classifying a type of the context extracted in the context extracting module
a search controller for determining a search request condition for related/accessory information about the context extracted and classified in the context extracting module and searching for the related/accessory information about the context according to the search request condition; and
a related information providing module for converting the related/accessory information about the context searched by the search controller through a predetermined Interface scheme and providing the related/accessory information.

2. The apparatus as claimed in claim 1, further comprising a database module for forming a field for storing at least one piece of information corresponding to the context extracted in the context extracting module and storing the at least one piece of information corresponding to the extracted contents;
wherein the search controller searches for related/accessory information about the extracted context in the database module correspondingly to the search request condition and extracts the related/accessory information.

3. The apparatus as claimed in claim 1, wherein the search controller accesses an external web server through internetworking with a network to search for and extract the related/accessory information corresponding to the context, receives a corresponding result from the web server, stores the result in the database module, and provides the result to the user equipment.

4. The apparatus as claimed in claim 2, wherein the database module comprises at least one of a person information field, a company information field, and a language information field, the person information field including related/accessory information corresponding to a specific person, the company information field including related/accessory information corresponding to a specific company, and the language information filed including an electronic dictionary proving related/accessory information corresponding to a specific text.

5. The apparatus as claimed in claim 1, wherein the context extracting module classifies a type of the multimedia data based on a header of the multimedia data received through the multimedia data receiving module.

6. The apparatus as claimed in claim 1, wherein the context extracting module extracts the context by extracting keywords, if the type of the multimedia data is text.

7. The apparatus as claimed in claim 1, wherein the context extracting module extracts the context by converting audio data into corresponding text and extracting keywords, from the text data, if the type of the multimedia data is voice.

8. The apparatus as claimed in claim 1, wherein the context extracting module extracts the context by performing image recognition and extracting an object, if the type of the multimedia data is an image.

9. The apparatus as claimed in claim 1, wherein the related/accessory information about the context provided through the related information providing module is displayed on a display module of the user equipment together with multimedia data.

10. A user equipment enabling a multimedia service in a multimedia communication system, the user equipment comprising:
an input module including an information input unit, an image acquisition unit, and a voice recognition unit, the information input unit receiving predetermined text information from a user, the image acquisition unit acquiring an external image, and the voice recognition unit receiving a predetermined audio signal;
a multimedia data communication module for transmitting and receiving one of only multimedia data and multimedia data and related/accessory information about the context with a predetermined Web server through a network interface;
a smart interpreter for extracting context of multimedia data received through the multimedia data communication module, determining and classifying a type of the extracted context, and searching and providing related/accessory information corresponding to the extracted and classified context; and
an output module for simultaneously providing the received multimedia data and related/accessory information about the multimedia data.

11. The user equipment as claimed in claim 10, wherein the smart interpreter comprises:
a context extracting module for extracting and classifying context of multimedia data input through one of the input module and the multimedia data communication module;
a database module for forming a field for related/accessory information about a context of the multimedia data and storing the related/accessory information;
a search controller for determining a search request condition of the related/accessory information about the context extracted and classified in the context extracting module and controlling a search of the related/accessory information about the context according to the search request condition; and
a related information providing module for converting the related/accessory information searched by the search controller through a scheme corresponding to an interface scheme of the user equipment and providing the related/accessory information to the output module.

12. The user equipment as claimed in claim 11, wherein the search controller searches for related/accessory information about the extracted context in the database module in response to a user search request and extracts the related/accessory information.

13. The user equipment as claimed in claim 12, wherein, if the related/accessory information does not exist, the search controller searches for the related/accessory information corresponding to the context through an external Web server by internetworking with the multimedia data communication module, extracts the related/accessory information, receives a corresponding result, stores the related/accessory information in the database module, and provides the related/accessory information to the output module.

14. The user equipment as claimed in claim 11, wherein the database module comprises at least one of a person information field, a company information field, and a language information field, the person information field including related/accessory information corresponding to a specific person, the company information field including related/accessory information corresponding to a specific company, and the language information filed including an electronic dictionary proving related/accessory information corresponding to a specific text.

15. The user equipment as claimed in claim 11, wherein the context extracting module classifies a type of the multimedia data based on a header of the multimedia data input through the input module or the multimedia data communication module.

16. The user equipment as claimed in claim 11, wherein the context extracting module extracts the context by extracting keywords, if the type of the multimedia data is text.

17. The user equipment as claimed in claim 11, wherein the context extracting module extracts the context by converting audio data into text data corresponding to the voice data and extracting keywords from the text data, if the type of the multimedia data is voice.

18. The user equipment as claimed in claim 11, wherein the context extracting module extracts the context by performing image recognition and extracting an object, if the type of the multimedia data is an image.

19. The user equipment as claimed in claim 11, wherein the related/accessory information about the context provided through the related information providing module is provided to the output module together with multimedia data.

20. The user equipment as claimed in claim 11, wherein the user equipment requests accessory information about the multimedia data through a network interface, receives the requested accessory information from a predetermined search server, and provides the requested accessory information.

21. A method for extracting a context of multimedia data and providing accessory information related to the context in a communication system, the method comprising the steps of:
classifying a type of input multimedia data;
detecting context of the multimedia data through a search scheme corresponding to the classified multimedia data;
determining a search request condition of related/accessory information corresponding to the detected context;
receiving the related/accessory information about the context by searching the related/accessory information corresponding to the context, if a related/accessory search condition is satisfied as a determination result of a search condition; and
providing the multimedia data and the related/accessory information about the context of the multimedia data to a user.

22. The method as claimed in claim 21, wherein, in the step of classifying the type of the multimedia data, comprises the step of classifying the type of the multimedia data based on a header of the multimedia data.

23. The method as claimed in claim 21, wherein, in the step of detecting the context of the multimedia data, corresponding keywords are extracted, if the type of the multimedia data is text.

24. The method as claimed in claim 23, wherein the keywords are extracted by natural language processing text data and determining if a natural language corresponding to preset keywords exists.

25. The method as claimed in claim 23, wherein, in the step of detecting the context of the multimedia data, text keywords corresponding to voice data are extracted, if the type of the multimedia data is the voice.

26. The method as claimed in claim 25, wherein the keywords are extracted by converting the voice data into corresponding text data using a voice recognition scheme processing the text through natural language processing, and determining if a natural language corresponding to predetermined keywords exists.

27. The method as claimed in claim 21, wherein, in the step of detecting the context of the multimedia data, the context is extracted by performing image recognition and object extraction, if the type of the multimedia data is an image.

28. The method as claimed in claim 27, wherein the image recognition and the object extraction steps employ one of a neural network scheme and a template matching scheme, to extract the context.

29. The method as claimed in claim 21, wherein, in the step of determining the search request condition of the related/accessory information, the determination for the search request condition is achieved correspondingly to at least one of a user direct triggering, a user request, and a predetermined request condition of a service provider.

30. The method as claimed in claim 29, further comprising the steps of:
checking a context selected by the user in multimedia data in a case of a request condition through the user direct triggering;
checking the context according to a situation preset by the user by determining if the request condition corresponds to the preset situation; and
checking the context according to a situation preset by a service provider by determining if the request condition corresponds to the situation.

31. The method as claimed in claim 21, wherein, in the step of searching the related/accessory information, related/accessory information about the context for the multimedia data corresponding the search condition is searched in a database module.

32. The method as claimed in claim 21, wherein, in the step of searching the related/accessory information, if related/accessory information about context corresponding to the search request condition does not exist in a database module, the related/accessory information corresponding to the context is searched through access to an external web server, and the search result is received from the web server and stored in the database module.

33. The method as claimed in claim 21, wherein, in the step of searching the related/accessory information, at least one piece of related/accessory information corresponding to a specific person, related/accessory information corresponding to a specific company, and related/accessory information corresponding to a specific text is searched.

34. The method as claimed in claim 21, wherein, in the step of providing the multimedia data and related/accessory information about context of the multimedia data to a user, the related/accessory information is provided to a display module together with the multimedia data.

35. A method for extracting a context and providing accessory information related to the context in a multimedia communication system, the method comprising the steps of:
transmitting the multimedia data to a smart interpreter, if predetermined multimedia data is requested;
extracting, by the smart interpreter a context for the multimedia data;
searching related/accessory information corresponding to the extracted context;
providing the related/accessory to a user equipment; and
displaying the related/accessory information about the context together with the multimedia data, if the related/accessory information is received from the smart interpreter.

36. The method as claimed in claim 35, further comprising the steps of:
classifying a type of the received multimedia data;
detecting the context by extracting keywords if the type of the multimedia data is text;
performing conversion into text corresponding to voice and extracting keywords if the type of the multimedia data is voice;
performing image recognition and extracting an object if the type of the multimedia data is an image;
determining a search condition of the related/accessory information about the detected context; and
receiving related/accessory information about context through search of the related/accessory information corresponding to the context, if it is determined that the search condition satisfies a search condition for the related/accessory information,
wherein the related/accessory information is provided to the user equipment together with the multimedia data.

37. The method as claimed in claim 36, wherein, in the step of classifying the type of the received multimedia data, the type of the received multimedia data is classified based on a header of the multimedia data.

38. The method as claimed in claim 36, wherein, in the step of determining the search request condition of the related/accessory information, the determination for the search request condition is achieved corresponding to at least one of a user direct triggering, a user request, and a preset request condition of a service provider.

39. The method as claimed in claim 36, wherein, in the step of searching the related/accessory information, related/accessory information about context for the multimedia data corresponding to the search condition is searched in a database module.

40. The method as claimed in claim 36, wherein, in the step of searching the related/accessory information, if related/accessory information about context corresponding to the search request condition does not exist in a database module, the related/accessory information corresponding to the context is searched through access to an external web server, and the search result is received from the web server and stored in the database module.
